(19) United States
(12) Patent Application Publication
(10) Pub. No.: US 2004/0257212 A1
(43) Pub. Date: Dec. 23, 2004

(54) Warning device able to set speeds of an automobile

(76) Inventor: Wen-Chang Wang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/463,335

(22) Filed: Jun. 18, 2003

(51) Int. Cl. B60Q 1/00

(52) U.S. Cl. 340/441

(57) ABSTRACT

A warning device able to set speeds of an automobile includes a speed detecting circuit for obtaining the rotating speed signals of an automobile. A speed record processor records the instant speed signals transmitted from the speed detecting circuit. A speed-setting mode contains a high-speed and a low-speed setting key respectively pressed to have the running speed signals stored in the speed record processor when the automobile is running. A release key connected with the speed record processor can be pressed to cancel the preset speed recorded in the speed record processor. A warning device connected with the speed record processor can be actuated to give out a warning signal when the automobile is running at a speed higher or lower than the speed signal preset.

### BACKGROUND OF THE INVENTION

1. Field of the Invention

This invention relates to a warning device able to set speeds of an automobile, particularly to one installed in an automobile for a driver to set a low and high speed by himself in accordance with the speed limits required at different sections of a road. When the automobile is running at a speed lower than the set low speed or faster than the set high speed, the warning device will be actuated to give out a warning signal to remind the driver, therefore the driver can drive with concentration and pay no attention to the speedometer on the instrument panel, increasing safety in driving.

2. Description of the Prior Art

Needless to say, automobiles are almost indispensable in our daily life nowadays, and safely in driving has become an important concern to drivers. To have regard for the safety of the driver himself as well as for people and other cars around, a highest speed limit for an automobile is set to most roads, while a lowest speed limit is set to a superhighway and a freeway so as to avoid traffic congestion caused by the automobiles, which are running too slowly.

However, in most cases, a driver who is driving and expects to know an running speed of his automobile at any moment has to watch the speedometer on the instrument panel and try to adjust the running speed in order to avoid being got fined because of driving at a speed faster than the highest speed or lower than the lowest speed limited. But, at this time, the driver may distract his mind from driving, impossible to pay close attention to the road situation forward, and subsequently traffic accident may happen if any unexpected situation should occur all of a sudden and the driver cannot immediately react to that situation.

### SUMMARY OF THE INVENTION

The objective of the invention is to offer a warning device able to set speeds of an automobile, which is installed in an automobile and provided with a speed detecting circuit for obtaining the running speed signals of the automobile with a wired or wireless way. The speed detecting circuit is connected with a speed record processor for recording an instant speed signal transmitted from the speed detecting circuit. The speed record processor is connected with a speed setting mode having a high-speed setting key and a low-speed setting key, and a release key able to cancel the set speed signals. Besides, the speed record processor has its output port connected with a warning device. Thus, when the running speed of the automobile is higher or lower than the speed signal respectively set by the high-speed and the low-speed setting key, the speed record processor will output a signal to actuate the warning device to give out a warning signal to remind the driver.

### BRIEF DESCRIPTION OF DRAWINGS

This invention will be better understood by referring to the accompanying drawings, wherein:

FIG. 1 is a block diagram of a warning device able to set speeds of an automobile in the present invention:

FIG. 2 is a diagram of the wired connecting circuit of the warning device in the present invention:

FIG. 3 is a diagram of the wireless connecting circuit of the transmitter of the warning device in the present invention: and

FIG. 4 is a diagram of the wireless connecting circuit of the receiver of the warning device in the present invention.

### DETALED DESCRIPTION OF THE PREFERRED EMBODIMENT

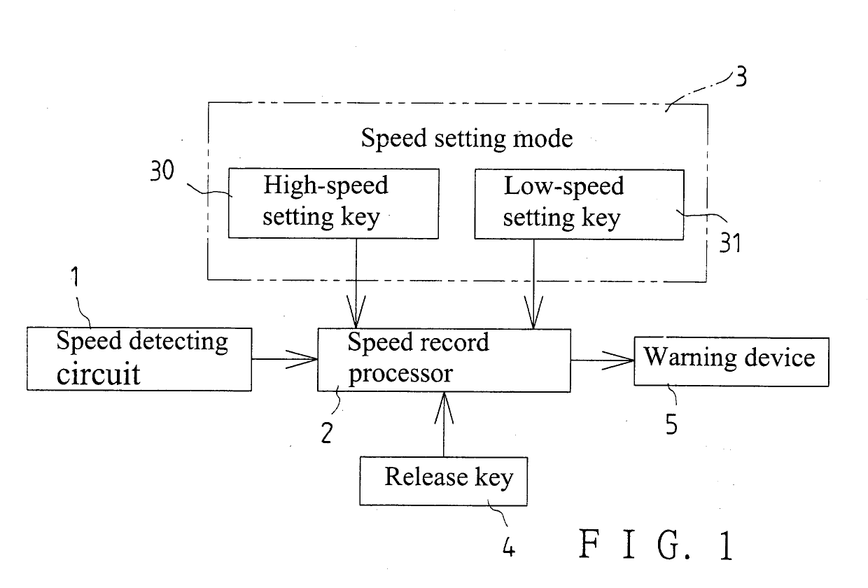

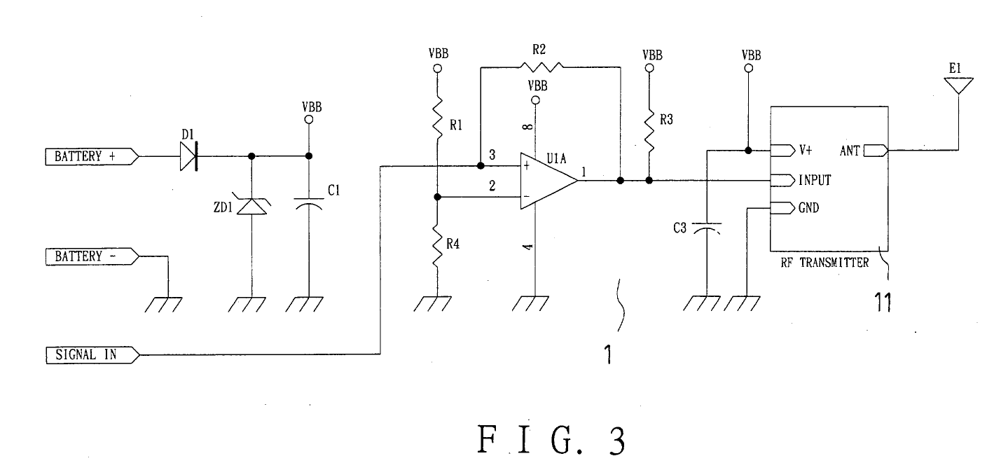

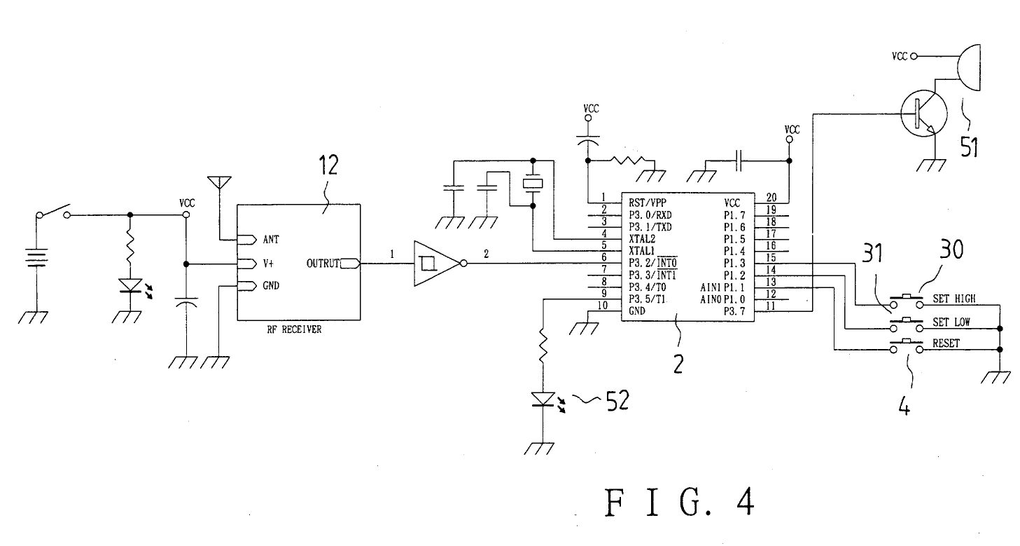

A preferred embodiment of a warning device able to set speeds of an automobile in the present invention, as shown in FIGS. 1 to 4, includes a speed detecting circuit 1, a speed record processor 2, a speed setting mode 3, a release key 4 and a warning device 5 combined together.

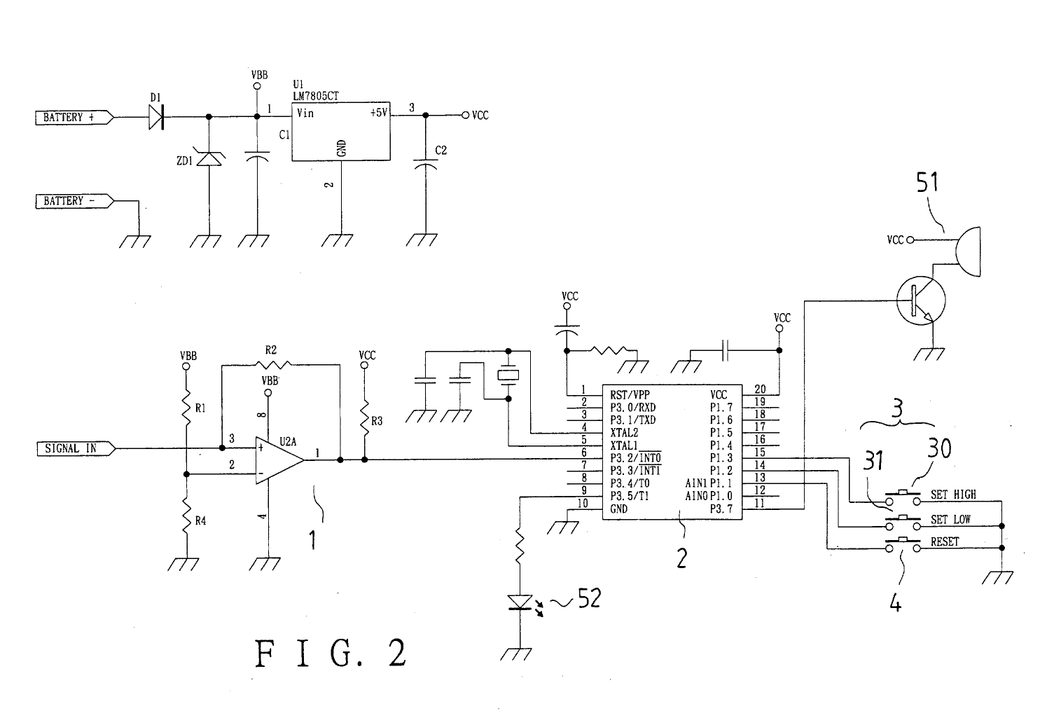

The speed detecting circuit 1 is directly connected with an electric wire extending out of the rotating speed inductor of the automobile, or connected in parallel with the intermediate terminal of foresaid electric wire, able to obtain the rotating speed signals of the automobile, as shown in FIG. 2. In addition, a wireless transmitter 11 can be installed at a point where the rotating speed inductor of an automobile is located, and a wireless receiver 12 can be installed near the driver's seat, equally able to obtain the rotating speed signals of the automobile through wireless transmission and detect the real speed of the automobile accurately.

The speed record processor 2 is connected with the speed detecting circuit 1, able to record the instant speed signals input from the speed detecting circuit 1 and also having function of controlling output signals.

The speed setting mode 3 is connected with the speed record processor 2, able to directly obtain the instant speed signals recorded by the speed record processor 2. The speed-setting mode 3 contains a high-speed setting key 30 and a low-speed setting key 31. When the automobile runs at a speed respectively reaching a low and high speed limit, the high-speed and the low-speed setting key 30, 31 are respectively pressed to set the speed limit.

The release key 4 is connected with the speed record processor 2 and can be pressed to cancel the speed data preset by the speed setting mode 3 and recorded in the speed record processor 2 so that a driver can reset a speed.

The warning device 5 connected with the speed record processor 2 can be a sound warning device 51 or a lamp indicator 52. When an automobile runs at a speed faster than the high speed or lower than the low speed set in the speed record processor, the warning device 5 will automatically be actuated to give out a warning signal to remind the driver of the running speed at that moment.

In operating, when driving at a speed reaching the limited lowest speed of a section of a road, press the low-speed setting key 31 of the speed-setting mode 3 to have the speed data recorded in the speed record processor 2. When the automobile begins to run at a speed reaching the limited highest speed of the section of a road, press the high-speed setting key 30 to have the speed data recorded in the speed record processor 2. Thus, a driver can drive with concentration, needless to pay attention to the speedometer on the instrument panel. Once the automobile begins to run at a speed lower than the low speed limit or faster than the high speed limit, the speed record processor 5 will output a signal to actuate the warning device 5 to give out a warning signal to remind the driver, able to increase safety in driving. To alter the preset high speed and low speed recorded in the speed record processor 2, only depress the release key 4 to cancel the preset speed data, and then the driver can reset a needed speed.

While the preferred embodiment of the invention has been described above, it will be recognized and understood that various modifications may be made there in and the appended claims are intended to cover all such modifications that may fall within the spirit and scope of the invention.

What is claimed is:

1. A warning device able to set speeds of an automobile comprising:
A speed detecting circuit for obtaining rotating speed signals of an automobile:
A speed record processor connected with said speed detecting device, capable to record the rotating speed signals transmitted from said speed detecting circuit:
A speed setting mode connected with said speed record processor, capable to directly obtain instant rotating speed signals recorded by said speed record processor, said speed setting mode consisting of a high-speed setting key and a low-speed setting key, a driver able to press said high-speed and said low-speed setting key by himself according to a condition of the road on which his automobile is running, said high-speed setting key pressed to have an instant running speed signal stored in said speed record processor as a high speed setting signal when the automobile is running, said low-speed setting key pressed to have an instant running speed signal stored in said speed record processor as a low speed setting signal when the automobile is running:
A release key connected with said speed record processor, said release key pressed to cancel the preset speed data recorded in said speed record processor, enabling a driver reset a needed speed: and
A warning device connected with the output port of said speed record processor, said output port of said speed record processor able to output a signal to actuate said warning device to give out a warning signal to remind the driver when the running speed of the automobile is higher than the high speed signal set by said high-speed setting key and stored in said speed record processor, or lower than the low speed signal set by said low-speed setting key and stored in said speed record processor.

2. The warning device able to set speeds of an automobile as claimed in claim 1, wherein said speed detecting circuit can be directly connected with an electric wire extending out of the rotating speed inductor of the automobile.

3. The warning device able to set speeds of an automobile as claimed in claim 1, wherein said speed detecting circuit can transmit the speed signals of the rotating speed inductor of the automobile by means of a wireless transmitter, and the signals can be received by a wireless receiver positioned near the driver's seat.

4. The warning device able to set speeds of an automobile as claimed in claim 1, wherein said warning device is a sound warning device.

5. The warning device able to set speeds of an automobile as claimed in claim 1, wherein said warning device is a lamp indicator
